(19) United States
(12) Patent Application Publication
(10) Pub. No.: US 2004/0157096 A1
(43) Pub. Date: Aug. 12, 2004

(54) Plug-compatible modular thermal management packages

(76) Inventor: Richard B. Peterson, Corvallis, OR (US)

Correspondence Address: LORI M FRIEDMAN, 300 BENTON VIEW DRIVE, PHILOMATH, OR, 97370, US

(21) Appl. No.: 10/677,427

(22) Filed: Oct. 2, 2003

Related U.S. Application Data
(60) Provisional application No. 60/416,651, filed on Oct. 7, 2002.

(51) Int. Cl. H01M 8/12; H01M 8/04

(52) U.S. Cl. 429/13; 429/26; 429/30

(57) ABSTRACT

The invention relates to plug-compatible modular thermal management packages of small elevated temperature devices that act as easily replaceable miniaturized sources of power, heat, or chemical reaction products. The modules may be solid oxide fuel cells, combustion heat generators, or miniature chemical reactors. The devices operate at elevated temperature in sealed, insulated thermal envelopes. The technology permits such devices to operate in a thermally efficient manner that minimizes heat loss to the environment. The thermal management packages are easily replaceable when spent.

### RELATED PATENT APPLICATIONS

This application is a United States utility patent application based on Provisional Patent Application 60/416,651 entitled “Thermal Packaging System for Small-Scale Solid Oxide Fuel Cells” filed on Oct. 7, 2002.

### BACKGROUND OF THE INVENTION

1. Field of the Invention

In one aspect, this invention relates to a device that allows the easy replacement of a power source which supplies energy to operate small electronic devices. In another aspect, the plug compatible module is incorporated as a thermal management package that can be plug-replaceable as needed. Furthermore, the invention concerns a method for the generation of power by such miniature solid oxide fuel cells (SOFC). Yet another aspect of this invention is to provide a portable moderate-to-high temperature heat source based on combustion. Still another aspect of this invention involves miniature chemical reactors, which produces an actual desired chemical reaction product.

2. Background and Related Art

Fuel cells are one of the cleanest and most efficient technologies for power generation available. Since there is no combustion, there are none of the pollutants commonly produced by furnaces and boilers. Much written material on the topic of fuel cells is concerned with generation of large quantities of power, such as would be required by utilities supplying power to homes and industry.

Searching patent and other literature on solid oxide fuel cells uncovers large amounts of material. There has been volumes written about solid oxide fuel cells with regard to their use in power plants, home heating and power systems, and many industrial applications. The idea of a miniature, modular energy system is not found, particularly as pertaining to plug-compatibility.

Regarding modularity, Elangovan et al in U.S. Pat. No. 5,480,738 discusses fuel cell modules with mention of their interconnection. The modules of '738 are not in any small or plug compatible form, as are the devices of the instant invention. Likewise, Gillett et al. in U.S. Pat. No. 5,741,605 discusses a solid oxide fuel cell with removable modular stack configurations. Far from being miniaturized, the removable modules are parts of an electrical power plant.

For the purposes of the present invention, miniaturized, plug-compatible thermal management packages represent an easily-replaceable, plug-compatible means to supply power to a relatively small electronic device, which device may be compact and portable. In this way, the easily-replaceable solid oxide fuel cell of this invention is analogous to batteries that supply power to such devices. Such devices include personal computers, PDAs, cellular telephones, portable global positioning systems (GPS) and the like. Their plug-compatibility is analogous to light bulb replacement; especially quartz-halogen light bulbs.

### SUMMARY OF THE INVENTION

The current invention relates to a miniaturized, easily replaceable, plug compatible thermal management package sealed in at least one insulated envelope comprising

a) at least one air inlet;

b) at least one fuel inlet;

c) a plurality of connectors to receive and supply electric power;

d) an exhaust outlet

and, optionally

e) a counter-flow heat exchanger; and

f) an ignitable catalytic combustor;

combined with a second plurality of connectors which are plugged into a mating socket to supply and accept both electrical power and gas flow.

In such a system, the recovery of thermal energy is by means of a counterflow heat exchanger, efficient thermal insulation, combustion of residual fuel, and cell isolation design with a minimal heat loss to the surroundings, and which provides high performance and efficiency to the system. Heat loss minimization by the thermal insulation barrier can comprise, for example, a vacuum multi-foil insulation (VMI) envelope, or evacuated or gas-filled fibrous ceramic insulation or Aerogel-type material. The various means of energy saving and recovery are enveloped in hermetic packaging. The different insulations can be combined in a particular thermal management system if they are compatible. In the thermal management system of this invention an electrical igniter connector is necessary to initiate the start-up sequence.

The thermal packaging schemes embodied in the present invention for small-scale power, heat or chemical generation are embodied by easily replaceable, inexpensive plug-compatible modular thermal management packages comprising at least one hermetic envelope made of quartz, glass, metals with low thermal expansion properties such as ferritic steel or nickel-based super-alloys, and ceramic electrolytes and anode/cathode materials which function as the energy component of a portable power device.

A metal for connector feed-throughs that can bond to the quartz envelope would be molybdenum or tungsten with an oxide surface that can withstand the operating temperature and any other physical limitations of the SOFC unit of this invention. The feed-through connectors would be similar in nature as those found in quartz halogen light bulbs.

Key to the success of the thermal management package of a plug-compatible packaging concept that allows the fuel cell unit or other module of this invention to operate for a limited period of time after which time they will need replacing at periodic intervals while keeping ancillary systems intact.

Further details, description, and discussion on the operation of the plug-compatible modular thermal management packages of this invention follow below.

### BRIEF DESCRIPTION OF THE DRAWINGS

FIG. 1 depicts a single envelope design of a SOFC of this invention with reactants inlet, exhaust outlet, and catalytic combustor shown

FIG. 2 depicts a double envelope design of a SOFC of this invention with external connections shown

FIG. 3 shows compacted cross-sectional views of a double envelope design of a SOFC of this invention in both rectangular and circular shapes

FIG. 4A depicts a compacted cross-sectional view of a disc-shaped SOFC of this invention.

FIG. 4B depicts a top view of a disc-shaped SOFC of this invention.

FIG. 5 shows an arrangement of a plug-compatible thermal management package that generates heat from combustion.

FIG. 6 shows a plug-compatible thermal management package that performs chemical processing at elevated temperatures.

### DETAILED DESCRIPTION OF PREFERRED EMBODIMENTS

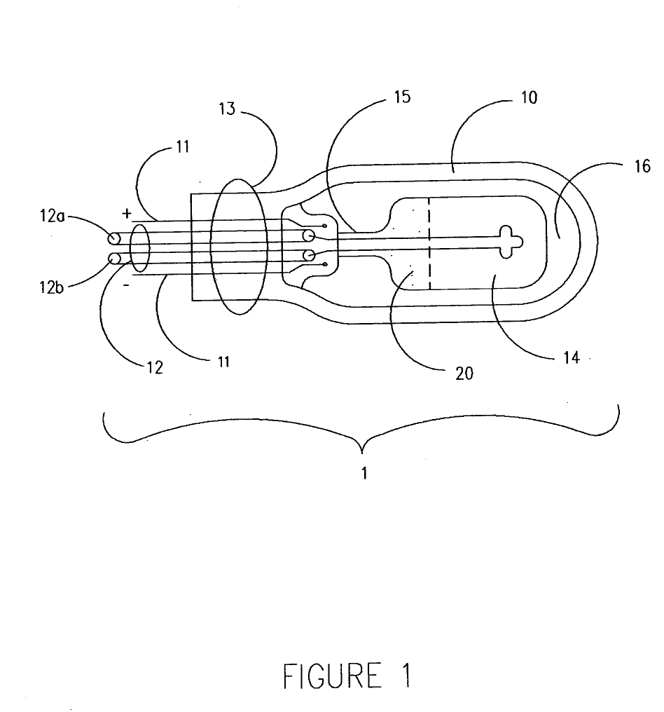

As seen in FIG. 1, the modular thermal management package 1 of this invention is analogous to a quartz-halogen light bulb where a hot filament is kept isolated from its surroundings by being enclosed in a quartz envelope that is able to withstand elevated temperature operation. In those bulbs, the external envelope 10 contains a halogen substance designed to enhance the lifetime of the extremely hot filament that it contains. Seen in FIG. 1 is a layer of vacuum insulation 16 which surrounds the SOFC 14 inside the envelope 10. In the present invention, the envelope contains an insulative environment 16 such as ceramic fibers, low density Aerogel, or vacuum conditions to minimize heat loss to the surroundings.

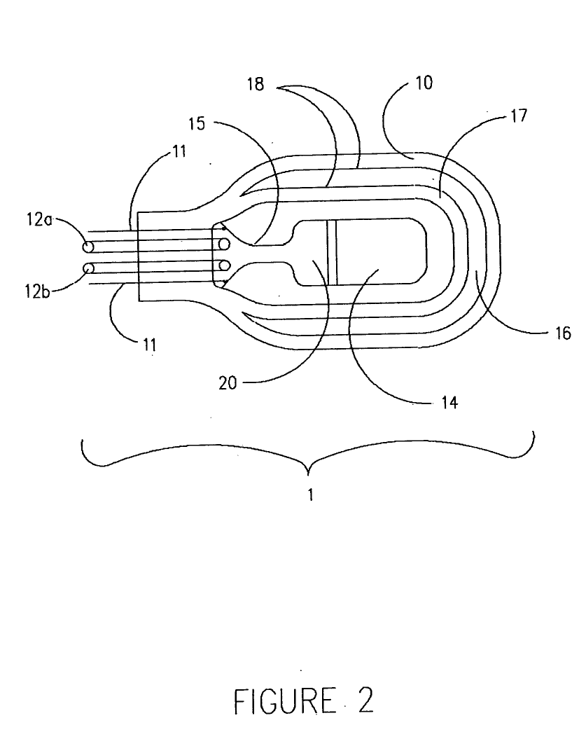

Depicted in FIG. 2, is an SOFC with a double envelope design. The modular thermal management package 1 of this embodiment provides power supplied by incorporating two electrode connectors 11 which connect the envelope 10 for supplying power to external devices. The packaging scheme for the replaceable, modular thermal packaged 1 will have different, distinctive features from a quartz-halogen bulb such as a catalytic combustor 20 and heat exchanger 15 that are required for its operation. The catalytic combustor 20 can be integrated directly into the SOFC 14 exhaust section to burn residual fuel.

Present in the double envelope design of FIG. 2 is a layer of vacuum insulation 16 which surrounds the SOFC 14 inside the envelope 10. In the double envelope design, there is an inner envelope 17 which is enclosed outer envelope 10. Another feature of the double envelope design of FIG. 2 includes reflective coatings 18 which surround the inner envelope 17

FIGS. 1 and 2 also show several requirements for SOFC operation including reactant supply and product exhaust 12, at least two electrical connections 11. Thermal management mechanisms of this invention may include a vacuum environment 16 or fibrous low density high-temperature ceramic insulation surrounding the SOFC 14. Or, alternatively, Aerogel or Aerogel-like insulating materials as well as vacuum multifoil insulation (VMI) may be used as insulation surrounding each SOFC 14.

It may be noted that Aerogel is a porous material with extreme microporosity made by high-temperature and pressure supercritical drying of a silicon dioxide gel comprising a colloidal silica structural units filled with solvents. The material is 99.8% air and is 1,000 times less dense than glass. Multifoil vacuum insulation, or vacuum multifoil insulation (VMI) is a material designed for thermal battery needs of advanced defense systems. It is designed to increase the operating life of a thermal battery from 2-3 hours to 68 hours

FIG. 1 is a diagram of one preferred embodiment of the modular thermal management package 1 of the present invention. As shown in FIG. 1, the external envelope 10 may be made from a variety of materials including glass or quartz, but quartz is preferred since it is operable at higher temperatures (up to 800 degrees C) than glass, which operates up to a temperature of 500 degrees C. This choice of material is analogous to that of the quartz-halogen lamp, which uses a tungsten filament encased in a quartz envelope to withstand high temperatures.

Also shown in FIG. 1 are the electrical feed-throughs 11 for cell operation. These can be similar to the quartz-halogen lamp design, but for reactant supply and product exhaust 12, the feed-throughs must be hollow tubes and be compatible with the reactants and products used for operation of a particular modular thermal management package 1.

It should be noted that if the reactants in a particular SOFC 14 must be kept separate they will each need a reactant line 12a. Fuels considered as possible for use in the SOFC 14 of this invention are hydrogen, ammonia, methanol, a low molecular weight hydrocarbon, or a reformate mixture. In this invention, a low molecular weight hydrocarbon will have a molecular weight less than or equal to 100 grams/mole. A preferred fuel is methanol or propane. Separate fuel lines 12a will be needed for fuel and air.

If the reactants are mixable, a simpler configuration of a single inlet and exhaust 12 will be used. In a preferred embodiment, the feed-through 13 will be compatible (have similar or matching thermal expansion coefficients and having sealing capability when joined together) with the external envelope 10 construction material. Having similar thermal expansion coefficients and the capability to form the hermetic seal are necessary to maintain vacuum or gas tight conditions inside the envelope 10, In order to conserve thermal energy in the product stream which emerges from the SOFC 14 at the cell temperature, the heat exchanger 15 is important. The heat exchange operation takes place before the exhaust products leave the SOFC 14.

Heat exchange takes place in the counterflow heat exchanger 15 where the product line 12b is in direct contact with the reactant line 12a along their streams. This permits thermal energy in the product stream to be transferred to the reactants, thus heating the reactants and cooling the products. This cools the products before they reach the envelope 10 seal at the base of the thermal package thus relieving some thermal stress on the modular thermal management package 1. The amount of heat exchanged between the reactants and the products will depend on the degree of heat loss tolerated for a specific cell design.

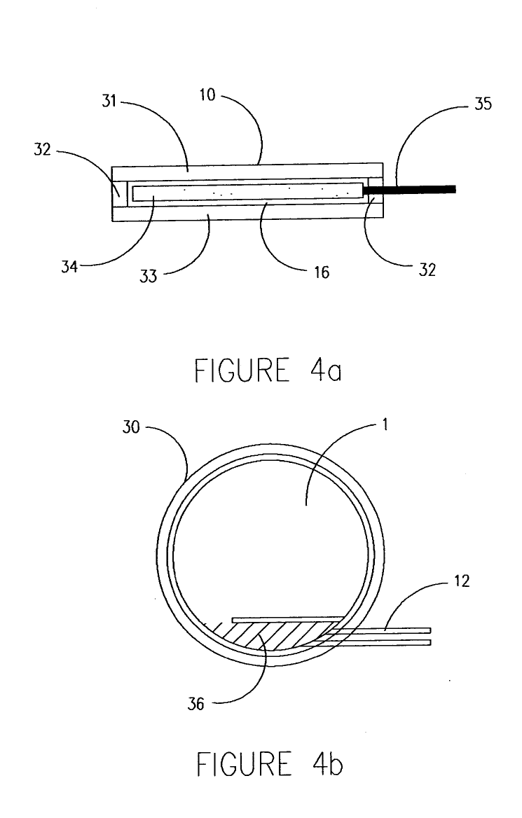

The environment surrounding the SOFC 14 shown in FIG. 4 and contained within the disc-shaped inner envelope 30 of this invention performs a thermal management function that allows the SOFC 14 to operate at temperatures between 500 C and 850 C. while maintaining the thermal package outer envelope 10 at a temperature level consistent with its surroundings. The modular thermal management package 1 will be generating waste heat from its operation. In addition, the modular thermal management package 1 may incorporate features to catalytically combust the effluent stream exiting the cell, which contains unreacted fuel and oxygen.

Insulation for cell operation is necessary because the heat generated by the device is insufficient to keep it at high temperatures if exposed to air or other high-convection surroundings. Radiation heat loss may also play a larger role as the size of the modular thermal management package 1 is reduced. One method of providing such insulation is to evacuate the outer envelope 10 while maintaining a hermetic seal around it. If the surface of the outer envelope 10 is coated with a thin film of gold or other low emissivity as a reflective coating 18, the heat radiation effects can be minimized and the convection heat loss can be virtually eliminated. However, when the cell is operating at 500 degrees C. or higher, radiation heat loss will be significant for smaller cells in the power range below 100 Watts, and more specifically below 10 Watts.

Another means of insulating the SOFC 14 from its surroundings is to pack the space between it and the envelope 10 with a fibrous, low-density high-temperature ceramic insulation. This means of insulation is preferred when the fuel cell unit is at the high end of its operating range, at about 10 Watts. The range of power that the modular thermal management package 1 will produce will range from about 10 milliwatts to about 10 watts. Replacing the air inside the envelope 10 with a higher molecular-weight gas causes an increase in the thermal resistance between the SOFC 14 and envelope 10 occurs and reduces the heat flow out of the modular thermal management package 1. By using fibrous ceramic insulation and a selected gas, the thermal resistance can be increased while relaxing the need for vacuum conditions on the inside of the envelope 10, resulting in a more practical arrangement for the thermal packaging system for small-scale the modular thermal management package 1 of this invention.

Yet another means of insulating the SOFC 14 is to maintain a tight vacuum within the envelope 10. Alternately, an inner and an outer quartz (or glass) envelope can be used. Each of the vacuum-facing glass surfaces is metalized to reduce infrared radiation heat transfer, after which the SOFC 14 is placed into the envelope 10 and the space between the inner and outer envelopes would be evacuated.

The envelopes of this invention are maintained longer and maintain at a higher level of thermal isolation for the SOFC 14 and performance of the modular thermal management package 1. Gettering can be provided by a pellet of material specifically formulated to adsorb residue gasses inside the vacuum envelope 10.

The configurations described above explain the use of miniaturized modular thermal management packages 1 of this invention as easily replaceable energy sources that are spent and interchanged as easily as are quartz/halogen light bulbs. As a miniaturized unit or module, its size may range from about 0.1 to about 10 inches.

Another embodiment of the instant invention is a disc-shaped unit shown in FIG. 4 whose envelope 30 is comprised of an upper disc 31, a center washer 32, and a lower disc 33 bonded together and forming a cavity in the center of a disc-shaped fuel cell 34. In this embodiment a plurality of feed-throughs 35 are necessary including supply lines, exhaust lines, and electrical lines.

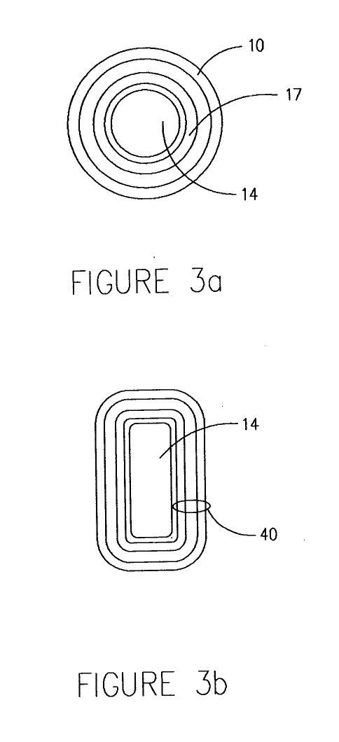

FIG. 3 shows cross-sectional views of circular 3a and rectangular 3b packaging arrangements for two of double envelope SOFC 14 units of this invention. In both of these views, the SOFC 14 is surrounded by two glass envelopes 10. The SOFC 14 of FIG. 3b on the right is enclosed in a double glass envelope 40. In either or both of these designs, a vacuum interior can be created with appropriate sealing technology. In addition, low-density fibrous ceramic insulation, Aerogel, VMI and the like can be used on the top, bottom, and around the perimeter of the modular thermal management package 1 for insulation. In certain cases, a specified gas such as carbon dioxide or Argon, could also be used with the insulative materials to improve the thermal isolation. It is important that the disc-shaped SOFC 34 inside the envelope 10 is centered in the disc for vacuum-insulated devices.

Such centering is done by thin, (or small-diameter) protrusions of not more than 0.040 inches (about 1 mm) coming out of the perimeter of the disc-shaped SOFC 34 wall to make contact with the outside washer 32. Alternatively, the supply and exhaust lines 12 (including both 12a and 12b) may be substantial enough to support the modular thermal management package 1.

A counterflow design should be used for the supply line 12a and the exhaust line 12b to recover the thermal energy in the product stream. If this supplies too much heat recovery and excess energy must be dissipated to the environment, the supply line 12a and exhaust line 12b could be re-routed to different locations. This would result in exhaust leaving the modular thermal management package 1 with substantial thermal energy. This may prove feasible if other losses, such as conduction and radiation, can be minimized.

FIG. 4 depicts a modular thermal management package 1 of this invention in a flat disc configuration. In FIG. 4a, a disc shaped SOFC 34 surrounded by an outer glass envelope 10. The flat disc configuration as seen in FIG. 4A also includes an integrated heat exchanger 36 and combustor 20 (not shown) as part of the flat disc configuration sofc 34 of the invention. The flat arrangement as shown in FIGS. 4a and 4b are applicable to larger surface applications that require a disc-shaped power source whose space constraints require thin, flat packaging of a modular thermal management package 1.

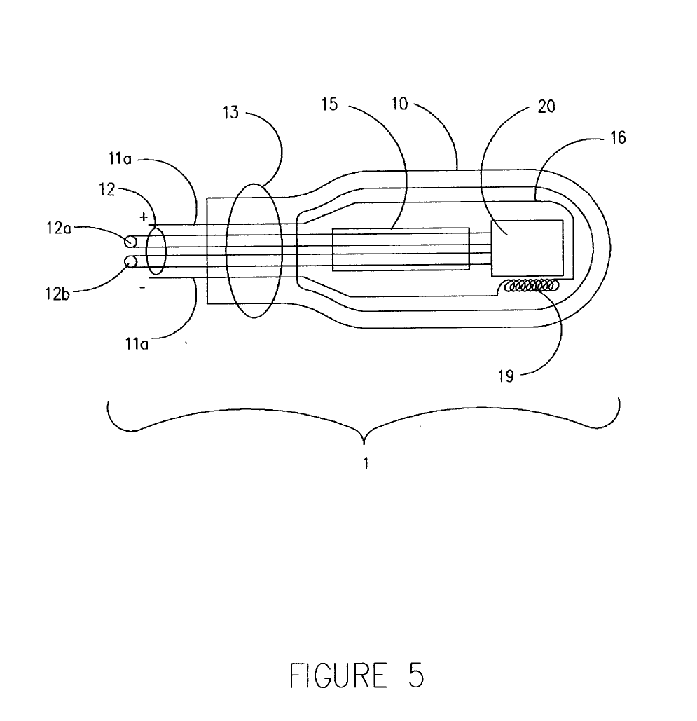

FIG. 5 depicts a modular thermal management package 1 that contains a unit that generates heat by burning a fuel in a catalytic combustor 20 which is ignited by a heater coil adjacent to the combustor 20. The heat product is emitted through exhaust 12b. An alternate arrangement for the combustion reaction depicted in FIG. 5, but not shown, is to have two reactant tubes and one exhaust line. In this manner, separate air and fuel lines can be used by the device.

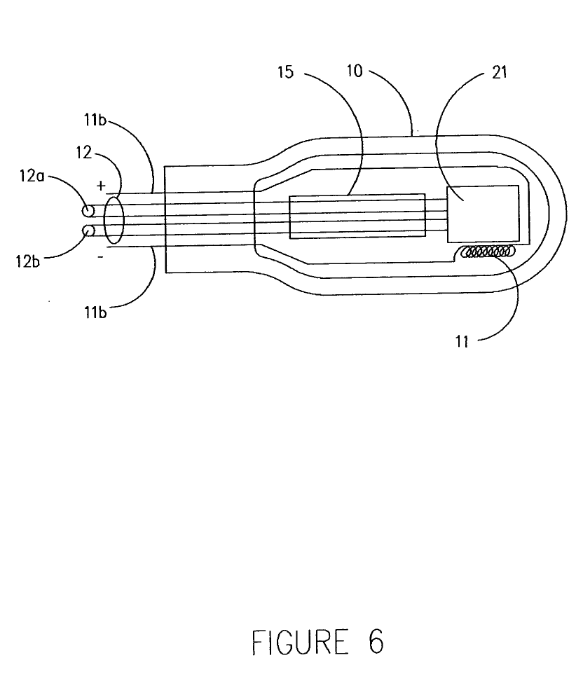

The modular thermal management package 1 depicted in FIG. 6 is miniature chemical reactor. These reactions can be endothermic and may take place at moderate or high temperatures. In this invention, moderate temperatures will range from about 200-500 degrees C., and high temperature will signify temperatures from 500 to 1000 degrees C. Examples of moderate temperature chemical reactions in this category are the decomposition of ammonia and the water-gas shift reaction.

In the water-gas shift reaction, entering the modular thermal management package 1 into inlet 12a are carbon monoxide (CO) and water (H₂O) which are converted, in the presence of a high temperature catalyst, to hydrogen (H₂) and carbon dioxide (CO₂)

### DISCUSSION

The above presents a description of the best mode contemplated of carrying out the present invention, and of the manner and process of making and using it, in such full, clear, concise, and exact terms as to enable any person skilled in the art to which it pertains to make and use this invention. This invention is, however, susceptible to modifications and alternate constructions from that discussed above which are fully equivalent. Consequently, it is not the intention to limit this invention to the particular embodiments disclosed. On the contrary, the intention is to cover all modifications and alternate constructions coming within the spirit and scope of the invention as generally expressed by the following claims, which particularly point out and distinctly claim the subject matter of the invention:

What is claimed is:

1. A miniaturized, easily replaceable, plug compatible thermal management package sealed in at least one insulating envelope comprising
a) at least one air inlet;
b) at least one fuel inlet;
c) a plurality of connectors to receive and supply electric power;
d) an exhaust outlet
and, optionally
e) a counter-flow heat exchanger; and
f) an ignitable catalytic combustor;
combined with a second plurality of connectors which are plugged into a mating socket to supply and accept both electrical power and gas flow.

2. The thermal management package of claim 1 wherein the plug-compatible thermal management system is a solid oxide fuel cell and wherein recovery of thermal energy is by means of a counterflow heat exchanger, efficient thermal insulation, combustion of residue fuel, cell design with a minimal conductive heat loss to the surroundings.

3. The thermal management package of claim 2 wherein heat loss is minimized by at least one thermal insulation barrier selected from the group consisting of a vacuum multi-foil insulation envelope, an evacuated fibrous aerogel insulation and gas-filled fibrous ceramic insulation enveloped in hermetic packaging.

4. The thermal management package of claim 2 wherein the amount of power generated by the small-scale solid oxide fuel cell ranges from about 10 milliwatts to about 10 watts.

5. The thermal management package of claim 2 wherein the fuel entering the fuel inlet is selected from the group consisting of hydrogen, ammonia, methanol, ethanol, a reformate mixture and one or more low molecular weight hydrocarbons.

6. The thermal management package of claim 1 wherein the insulated envelope is constructed from a material selected from the group consisting of quartz, glass and metals with compatible thermal expansion properties including ferritic steel and nickel-based super-alloys.

7. The thermal management package of claim 1 wherein the package is a high temperature combustion system that generates heat by burning in a catalytic combustor which is ignited by a heater coil for combustion igniter, resulting in the production of heat.

8. The thermal management package of claim 1 wherein the package is a moderate to high temperature chemical reactor which generates at least one product of a chemical reaction.

9. An easily replaceable, inexpensive solid oxide fuel cell energy module comprising at least one envelope constructed from a material that is hermetic and selected from the group consisting of quartz, glass, and metals with compatible thermal expansion properties including ferritic steel and nickel-based super-alloys.

10. The energy module of claim 9 which further comprises at least one air inlet, at least one fuel inlet, a plurality of connectors to receive and supply electric power, an ignitable catalytic combustor, a means to ignite the combustor, a counter-flow heat exchanger, an exhaust outlet and a plurality of connectors which are plugged into a mating socket to supply and accept power and gas flow

11. The energy module of claim 9 wherein at least one solid oxide fuel cell is enclosed in a gas-tight envelope with a connector plug for facile replacement when spent.

12. The energy module of claim 9 wherein the gas-tight envelope further encloses an insulating member to reduce heat loss from the SOFC.

13. The energy module of claim 12 wherein the insulating member is a high-performance, high-temperature insulation that is selected from the group consisting of Aerogel, vacuum multifoil insulation, and low density fibrous ceramic insulation.

14. The energy module of claim 9 which is miniaturized and ranges in size from about 0.1 to about 10 inches.

15. The energy module of claim 9 wherein the connector plugs are arranged so that fuel, air, and exhaust are vented in to and out of the module at near-ambient temperature.

16. A method of supplying electric power to small portable electronic devices with a small-scale solid oxide fuel cell unit comprising
a) packing a hermetic envelope with insulation;
b) inserting a solid oxide fuel cell mating connector in the envelope;
c) sealing the envelope containing the solid oxide fuel cell for high temperature service;
d) evacuating the envelope;
e) inserting a connector module into the mating connector;
f) supplying air and fuel to the solid oxide fuel cell unit through the connector;
g) powering an igniter present on a catalytic combustor;
resulting in generating power to operate an electronic device

17. The method of claim 16 wherein the amount of power generated by the small-scale solid oxide fuel cell ranges from about 10 milliwatts to about 10 watts.

18. The method of claim 16 wherein the evacuated envelope is constructed from a material selected from the group consisting of quartz, glass and metals with compatible thermal expansion properties.

19. The method of claim 16 wherein the solid oxide fuel cell provides an inexpensive, replaceable, and plug-compatible means to supply power to a relatively small electronic devices selected from the group consisting of personal computers, PDAs, cellular telephones, and portable global positioning systems.

20. The method of claim 16 wherein the fuel used in the solid oxide fuel cell is selected from the group consisting of hydrogen, ammonia, methanol, ethanol, and one or more low molecular weight hydrocarbons.
